(19) United States
(12) Patent Application Publication
(10) Pub. No.: US 2016/0275124 A1
(43) Pub. Date: Sep. 22, 2016

(54) VISUAL SEARCH SYSTEM AND OPERATING METHOD THEREOF

(71) Applicant: Electronics and Telecommunications Research Institute, Daejeon (KR)

(72) Inventors: Seungjae LEE, Daejeon (KR); Keun Dong LEE, Daejeon (KR); Weon Geun OH, Daejeon (KR); DA-UN JUNG, Daejeon (KR); Sungkwan JE, Daejeon (KR)

(21) Appl. No.: 15/074,252

(22) Filed: Mar. 18, 2016

(30) Foreign Application Priority Data
Mar. 20, 2015 (KR) 10-2015-0039011

(51) Int. Cl. G06F 17/30

(52) U.S. Cl. CPC G06F 17/30345; G06F 17/30256; G06F 17/30241; G06F 17/30598

(57) ABSTRACT

Provided is a visual search system. The visual search system according to an embodiment of the inventive concept may include a database that stores characteristic information for a visual search, and a visual search update server that updates the DB based on an image of a target captured by a moving object or a fixed object. According to an embodiment of the inventive concept, it is possible to efficiently update a DB for a visual search because images captured by not only the moving object but also the fixed object are used.

### CROSS-REFERENCE TO RELATED APPLICATIONS

This U.S. non-provisional patent application claims priority under 35 U.S.C. §119 of Korean Patent Application No. 10-2015-0039011, filed on Mar. 20, 2015, the entire contents of which are hereby incorporated by reference.

### BACKGROUND

The present disclosure herein relates to a visual search, and more particularly, to a method of updating a DB (database) for a visual search by using a moving object and a fixed object.

A visual search is a technology to extract a target from an image or video to provide information on the target to a user. For the visual search, a DB should be first formed.

In the case where there is a need to obtain information on ordinary goods or article, updating and managing a DB may be of little importance. However, in the case where a visual search is performed in an urban area where a surrounding condition, such as a building sign frequently changes, updating and managing a DB are significantly important.

A general DB update, such as a DB update that is performed by user participation has a drawback in that the DB update is not continuous. Thus, in order to provide a good visual search service, forming a DB that may be continuously updated is being magnified as an important issue.

### SUMMARY

The present disclosure provides a method of efficiently updating a database for a visual search based on images captured by a moving object and a fixed object, regarding a visual search.

An embodiment of the inventive concept provides a visual search system includes a database configured to store characteristic information on a target, the characteristic information being classified into a plurality of categories according to a region to which a target belongs; and a visual search update server configured to receive position information on a moving object or a fixed object and an image of the target captured by the moving object or the fixed object, and compare characteristic information extracted from the received image with characteristic information stored in the database to execute a visual search.

In an embodiment, the visual search update server may be configured to drive: a position check unit configured to check a position of the moving object or the fixed object referring to the position information, an update history check unit configured to determine referring to the position information whether an update to characteristic information corresponding to a region to which the captured target belongs has been executed within a reference period, a visual search unit configured to extract the characteristic information from the received image, compare the extracted characteristic information with the characteristic information stored in the database to detect a position of the captured target, and determine whether there is a need to renew the characteristic information stored in the database, and a characteristic information structurization unit configured to renew characteristic information related to the captured target that is stored in the database, according to a result of the determination.

In an embodiment, the image of the target captured by the fixed object may be periodically received by the visual search update server.

In an embodiment, the position information on the moving object may be received by the visual search update server according to a request of a user of the moving object, and the position information on the fixed object may be received by the visual search update server or stored in the visual search update server.

In an embodiment, the characteristic information stored in the database may be classified into a plurality of groups according to a region to which a target corresponding to the characteristic information belongs.

In an embodiment, the visual search update server may detect a position of the captured target with reference to a group corresponding to a region to which the moving object or the fixed object belongs, among the plurality of groups.

In an embodiment, the position information may include information on departure and destination points of the moving object.

In an embodiment, the reference period may be determined based on information on the departure and destination points.

In an embodiment, the position information on the moving object may be obtained by a global positioning system (GPS).

In an embodiment of the inventive concept, a method of updating a database for a visual search includes

receiving an image of a target captured by a moving object or a fixed object and position information on the moving object or the fixed object; determining whether an update to characteristic information corresponding to a region to which the captured target belongs is executed within a reference period; according to a result of the determination, executing the visual search by comparing characteristic information on the captured with pieces of characteristic information stored in the database; and updating characteristic information related to the captured target, from among the pieces of the characteristic information stored in the database.

In an embodiment, the characteristic information on the target may be classified into a plurality of categories according to a region to which the target belongs, and stored in the database.

In an embodiment, the method may further include, after the receiving of the image, selecting a category for the visual search among the plurality of categories, based on the position information.

In an embodiment, the executing the visual search may include: extracting the characteristic information from the image of the target captured; comparing characteristic information in the selected category with characteristic information on the captured target; and searching for a position of the target according to a result of the comparison.

In an embodiment, the image of the target captured by the fixed object may be periodically received by a visual search update server.

In an embodiment, the receiving the image may include receiving information on departure and destination points of the moving object.

In an embodiment, the reference period may be determined based on information on the departure and destination points.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a visual search system according to an embodiment of the inventive concept;

FIG. 2 is a detailed block diagram of a visual search update server in FIG. 1;

FIG. 3 is a diagram conceptually showing the operation of a visual search system according to an embodiment of the inventive concept;

FIG. 4 is a flowchart of the operating method of a visual search system according to an embodiment of the inventive concept;

FIG. 5 is a flowchart of the operating method of a visual search system according to another embodiment of the inventive concept; and

FIG. 6 is a flowchart showing step S130 in FIG. 4 in detail.

### DETAILED DESCRIPTION

It should be understood that both the foregoing general description and the following detailed description are exemplary, and it should be appreciated that the additional description of the claimed invention is provided. Reference numerals are denoted in detail in the exemplary embodiments of the inventive concept and their examples are indicated in the accompanying drawings. The same reference numerals are used in the description and drawings in order to refer to the same or similar parts wherever possible.

It will be understood that when an element or layer is referred to as being “connected to”, “coupled to”, or “adjacent to” another element or layer, it may be connected, coupled or adjacent directly to the other layer, or intervening elements or layers may also be present inbetween. The term “and/or” used herein includes one of enumerated elements or combinations thereof.

Even though the terms “first” and “second” may be used for explaining various elements, these elements are not limited by these terms. The terms may only be used to distinguish one component from others. Thus, the terms first component, section and layer used herein may be used as second component, section and layer without departing from the spirit of the inventive concept.

The terms “lower”, “under”, “upper”, and “over”, and the terms similar thereto include a direct or indirect contact when components are arranged. In addition, the terms representing spatial relativity should be understood to include other directions in addition to directions shown in the drawings. For example, when a device is upside down, a component described with the term “lower” is changed to the term “upper”.

The terms used herein are only intended to explain specific embodiments but not limited thereto. The term “a” or “one” should be understood to include a plural form unless otherwise specified. The term “include,” “comprise,” “including,” or “comprising,” specifies the presence of a characteristic, step, operation, ingredient, and/or component but does not exclude the presence of another or more characteristics, steps, operations, ingredients, components, and/or their groups.

Embodiments of the inventive concept are described below with reference to the accompanying drawings so that a person skilled in the art may easily accomplish the technical spirit of the inventive concept.

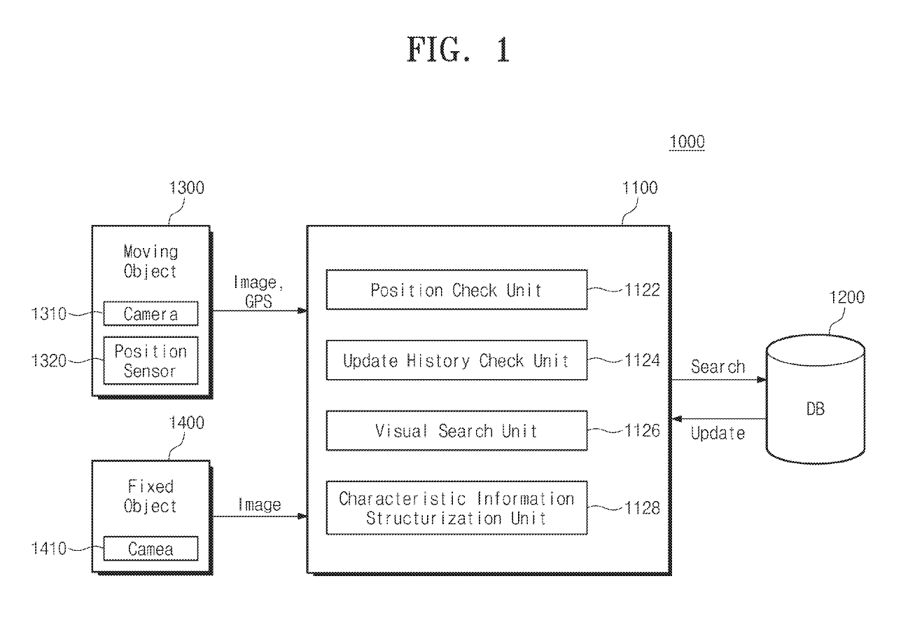

FIG. 1 is a block diagram of a visual search system according to an embodiment of the inventive concept. Referring to FIG. 1, a visual search system 1000 may include a visual search update server 1100 and a DB (database) 1200.

The visual search update server 1100 may receive an image of a target that is captured by a moving object 1300 (e.g., a user's mobile phone or a vehicle black box) or by a fixed object 1400 (e.g., CCTV). The visual search update server 1100 may receive position information on the moving object 1300 or the fixed object 1400. The visual search update server 1100 may use the position information to select a region searched from the DB 1200. In addition, the visual search update server 1100 may execute a visual search operation in which information on a target is provided with reference to data stored in the DB 1200.

According to an embodiment of the inventive concept, it is possible to use the advantages of both the moving object 1300 and the fixed object 1400 to update the image of the target. For example, while using the moving the moving object 1300 to capture the image of the target has an advantage in that it is possible to use inexpensive equipment (e.g., a user's mobile phone or a vehicle black box), there is a drawback in that the user of the mobile phone or the vehicle black box needs to participate. On the contrary, if the fixed object 1400 (e.g., CCTV) is used, it is possible to periodically capture the image of the target to update the image of the target, even without user participation. The visual search update server 1100 according to an embodiment of the inventive concept may use an image of a target that is captured by the fixed object 1400 (e.g., CCTV) in addition to the moving object 1300 (e.g., a user's mobile phone or a vehicle black box), to update the DB 1200. In this case, the visual search update server 1100 may periodically receive the image of the target from the fixed object 1400. The visual search update server 1100 may update the DB 1200 according to whether an update has been recently executed on a region on which the captured target is disposed. As a result, it is possible to efficiently update and manage the DB 1200.

As an embodiment, the visual search update server 1100 may include a position check unit 1122, an update history check unit 1124, a visual search unit 1126, and a characteristic information structurization unit 1128. For example, the position check unit 1122, the update history check unit 1124, the visual search unit 1126, and the characteristic information structurization unit 1128 may be modules that are driven as software. That is, the position check unit 1122, the update history check unit 1124, the visual search unit 1126, and the characteristic information structurization unit 1128 may be driven as software or firmware by various hardware devices, such as a CPU, a multi-processor, a distributed processing system, and an application specific integrated circuit (ASIC). However, the embodiment is not limited thereto and the position check unit 1122, the update history check unit 1124, the visual search unit 1126, and the characteristic information structurization unit 1128 may also be modules (circuits) that are fabricated as separate hardware.

The position check unit 1122 may identify the position of the moving object 1300 or the fixed object 1400 with reference to position information that is received from the moving object 1300 or the fixed object 1400. For example, the position information may be information that is based on a global positioning system (GPS). In addition, position information on the fixed object 1400 may also be previously stored in the visual search update server 1100. The position of the moving object 1300 or the fixed object 1400 that is identified by the position check unit 1122 may be used for enhancing visual search efficiency. For example, in visual search, it is possible to first search for pieces of characteristic information corresponding to a region to which the moving object 1300 or the fixed object 1400 belongs, among pieces of characteristic information stored in the DB 1200 to enhance search efficiency.

The update history check unit 1124 may check the update history of the DB 1200 to prevent the DB 1200 from becoming updated redundantly. In this case, the checking of the update history may be independent of a target that is captured by the moving object 1300 or the fixed object 1400. That is, if the update to the DB 1200 on a region to which the captured target belongs has been recently executed, the update to the DB 1200 may not be executed. The reason is that the exterior of a building that is one of the most general targets is not frequently or significantly changed.

The visual search unit 1126 may execute a visual search according to a request from a user of the moving object 1300. That is, if an image of a target captured by the moving object 1300 is transmitted to the visual search update server 1100, the visual search unit 1126 may extract characteristic information from the image of the target received. For example, the extraction of the characteristic information may be executed by the using of various detectors, such as a Harris detector, a Harris-Laplace detector, a scale invariant feature transform (SIFT) detector, a maximally scalable extremal regions (MSER) detector, and a speeded up robust features (SURF) detector. In addition, the visual search unit 1126 may compare the extracted characteristic information with the characteristic information stored in the DB 1200 to search for various pieces of information on a target. In this case, the visual search unit 1126 may only search for pieces of characteristic information corresponding to a region to which the target belongs, not all data stored in the DB 1200. That is, the pieces of characteristic information stored in the DB 1200 may be classified according to a region to which a target belongs (is placed). In addition, the information found by the visual search unit 1126 may be provided to a user.

If a visual search according to a user request is completed, the visual search unit 1126 may use position information on the moving object 1300 and/or characteristic information on a target captured by the moving object 1300 to determine whether there is a need to renew the target. For example, the determination of whether there is a need to renew may be executed by the comparing of the position information on the moving object 1300 and/or the characteristic information extracted from the image of the target with the characteristic information on the target stored in the DB 1200.

An operation of determining whether there is a need to renew a target, by using an image captured by the fixed object 1400 may also be executed in a similar manner. The fixed object 1400, such as a CCTV does not request a visual search, unlike the moving object 1300. However, the fixed object 1400 only captures an image of the target periodically or aperiodically and transmits it to the visual search update server 1100. If the image captured by the fixed object 1400 is transmitted to the visual search update server 1100, the visual search unit 1126 may extract characteristic information from the image of the target received. The visual search unit 1126 may use position information on the fixed 1400 and/or characteristic information on the target to determine whether there is a need to renew the target. For example, the determination of whether there is a need to renew may be executed by the comparing of the position information on the fixed object 1300 and/or the characteristic information extracted from the image of the target with the characteristic information on the target stored in the DB 1200.

If it is determined that there is a need to renew the characteristic information on the target, the characteristic information structurization unit 1128 may structurize a part that needs to renew, among pieces of characteristic information. In addition, the characteristic information structurization unit 1182 may request an update to the DB 1200.

According to the update request from the characteristic information structurization unit 1128, the DB 1200 may be updated. For example, the update to the DB 1200 would be executed with respect to a part that is received from the characteristic information structurization unit 1128 and needs to renew. That is, characteristic information stored in the DB 1200 that corresponds to the part needing to renew would be replaced with new characteristic information that is received from the visual search unit 1126. In order to facilitate a visual search, the DB 1200 may classify and store pieces of characteristic information according to a region to which a target belongs. For example, the DB 1200 may be a mass storage device, such as a solid state drive (SSD). However, the embodiment is not limited thereto.

According to an embodiment of the inventive concept, the visual search update server 1100 may update the DB 1200 with reference to an image of a target that is captured by not only the moving object 1300 but also the fixed object 1400. While capturing the image of the target by the moving object 1300 has an advantage in light of cost because it uses a user device (e.g., a mobile phone or vehicle black box), there is a drawback in that a visual search request from a user is needed. That is, since the data to the DB 1200 may not be periodically implemented, there is a drawback in light of data reliability. On the contrary, capturing the image of the target by the fixed object 1400 has an advantage in light of data reliability because it may be periodically executed even without a user request. As a result, since the advantages of both the moving object 1300 and the fixed object 1400 are used, it is possible to more efficiently update the DB 1200 for the visual search.

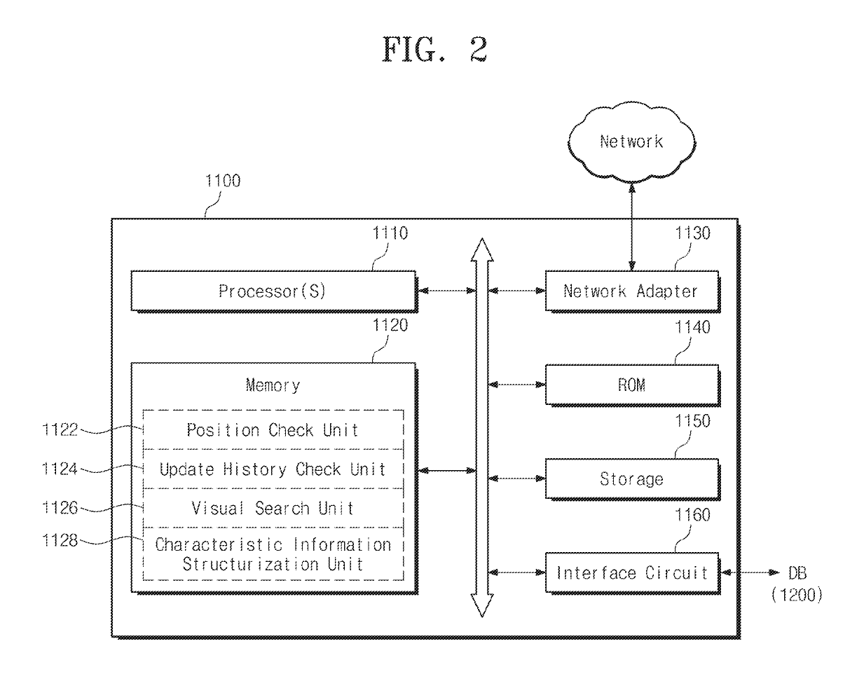

FIG. 2 is a detailed block diagram of the visual search update server in FIG. 1. Referring to FIG. 2, the visual search update server 1100 may include at least one processor 1110, a memory 1120, a network adapter 1130, a read only memory (ROM) 1140, a storage 1150, and an interface circuit 1160.

The processor 1110 may control the general operations of the visual search update server 1100. For example, the processor 1110 may include various hardware devices, such as a CPU, a multi-processor, a distributed processing system, and an ASIC. The processor 1100 may drive an operating system (OS) for driving the visual search update server 1100, the position check unit 1122, the update history check unit 1124, the visual search unit 1126, and the characteristic information structurization unit 1128. For example, the OS, the position check unit 1122, the update history check unit 1124, the visual search unit 1126, and the characteristic information structurization unit 1128 may be loaded onto the memory 1120 to be driven by the processor 1110.

The OS for driving or controlling the visual search update server 1100, the position check unit 1122, the update history check unit 1124, the visual search unit 1126, and the characteristic information structurization unit 1128 may be loaded onto the memory 1120. These modules loaded onto the memory 1120 may update a DB for a visual search.

The network adapter 1130 may provide the interface between the visual search update server 1100 and the moving object 1300 (See FIG. 1) or the fixed object 1400 (See FIG. 1).

The ROM 1130 may store code data needed for the initial booting of the visual search update server 1100.

Modules, such as the OS for driving the visual search update server 1100, the position check unit 1122, the update history check unit 1124, the visual search unit 1126, and the characteristic information structurization unit 1128 may be stored in the storage 1140. The storing of these modules in the storage 1140 corresponds to the case where the position check unit 1122, the update history check unit 1124, the visual search unit 1126, and the characteristic information structurization unit 1128 are driven as software by the processor. Thus, it may not correspond to the case where the position check unit 1122, the update history check unit 1124, the visual search unit 1126, and the characteristic information structurization unit 1128 are implemented in separate hardware (circuit).

The interface circuit 1150 may provide the interface between the visual search update server 1100 and the DB 1200. For example, the visual search update server 1100 and the DB 1200 may be connected through at least one of various standardized interfaces. The standardized interfaces may include various interfaces, such as advanced technology attachment (ATA), serial ATA (SATA), external SATA (e-SATA), small computer small interface (SCSI), serial attached SCSI (SAS), peripheral component interconnection (PCI), PCI express (PCI-E), universal serial bus (USB), IEEE 1394, and Card interfaces.

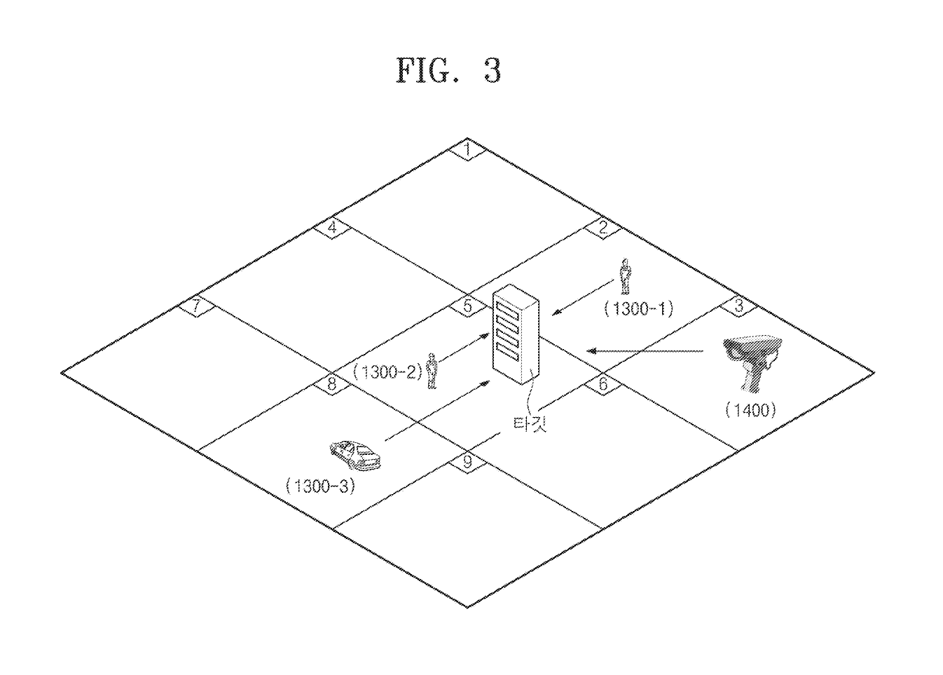

FIG. 3 is a diagram conceptually showing the operation of a visual search system according to an embodiment of the inventive concept.

Referring to FIG. 3, moving objects 1300-1 and 1300-3, a fixed object 1400, and a target (e.g., a building) are shown. As shown in FIG. 3, a target is placed on one (region 5) of a plurality of divided regions (regions 1 to 9). In addition, pieces of characteristic information that are stored in the DB 1200 (See FIG. 1) be also classified according to the plurality of divided regions. The moving objects 1300-1 and 1300-2 may be users that hold a smart phone or wearable device. The moving object 1300-3 may be a vehicle having a black box. The fixed object 1400 may be a device that may be fixed in one place to capture a surrounding image, such as a CCTV.

Images of a target that are captured by the moving objects 1300-1 to 1300-3 and the fixed object 1400 may be transmitted to the visual search update server 1100 (See FIG. 1). For example, the transmission of the images of the image by the moving objects 1300-1 to 1300-3 may be executed by user participation or feedback and the transmission of the image of the target by the fixed object 1400 may be executed by regular capturing by the fixed object 1400. Simultaneously with the transmission of the image of the target to the visual search update server 1100 (See FIG. 1), position information on the moving objects 1300-1 to 1300-3 and the fixed object 1400 may also be transmitted to the visual search update server 1100 (See FIG. 1). In this case, the position information may be GPS based information.

If there is a visual search request from a user (the visual search request involving the transmission of the image of the target by the moving object 1300), or the image captured by the fixed object 1400 is transmitted to the visual search update server 1100, the position check unit 1122 (See FIG. 1) of the visual search update server 1100 checks the positions of the moving objects 1300-1 to 1300-3 or the fixed object 1400. In addition, the visual search update server limits a search region in the DB 1200 (See FIG. 1) to characteristic information related to the region 5. As a result, a search time may decrease.

There may also be the case where a moving target and a target are on different regions, such as the case where the visual search request is received by a user of the moving object 1300-1. In this case, the visual search update server may first search for characteristic information related to the region 2 on which the moving object 1300-1 is placed, among pieces of characteristic information stored in the DB. In addition, it searches for pieces of characteristic information related to adjacent regions (e.g., region 1, region 3 and region 6) to execute a visual search operation. As a result, a search time may decrease. Images captured by the moving objects 1300-1 to 1300-3 or the image of the target captured by the fixed object 1400 may be transmitted to the visual search update server 1100 (See FIG. 1) according to a user request.

In the case where the visual search request from a user is received, the visual search update server first determines whether there is an update to characteristic information related to the region 5 to which the target belongs. If an update is not the update to the characteristic information related to the target but it is confirmed that an update has been executed within a reference period, the update to the target may not be executed. The reference period may be determined according to position information on a moving object. For example, the reference period may be determined according to information on the departure point and destination point of the moving object. If position information on the moving object received from any region is relatively abundant, it may mean that there is a lot of floating populations. In this case, by shortening the reference period, it is possible to increase the update frequency of the DB 1200. On the contrary, if position information on the moving object received from any region is relatively scarce, it would mean that there is a relatively small floating population. In this case, by extending the reference period, it is possible to decrease the update frequency of the DB 1200.

Although the moving object 1300-1 and the target are actually placed on the same region, there may be the case where the moving object 1300-1 and the target are identified as placed on different regions, due to an error in received GPS information. For example, GPS information may have an error of up to about 100 m. If the error in GPS is not considered, a result of omitting an update may also occur even though there is a need to update the DB 1200. Thus, in the case where a visual search request is received from a user, it is possible to determine based on the received position information, e.g., a region within a radius of about 100 m whether an update has been executed within a reference period. According to the visual search result, the accurate position (e.g., GPS coordinates) of the target may be checked and it is possible to estimate an appropriate GPS error based thereon. Thus, if the GPS error is considered upon the update to the DB 1200, it is possible to more efficiently update the DB 1200 and it would be possible to avoid the update to the DB 1200 from becoming skipped.

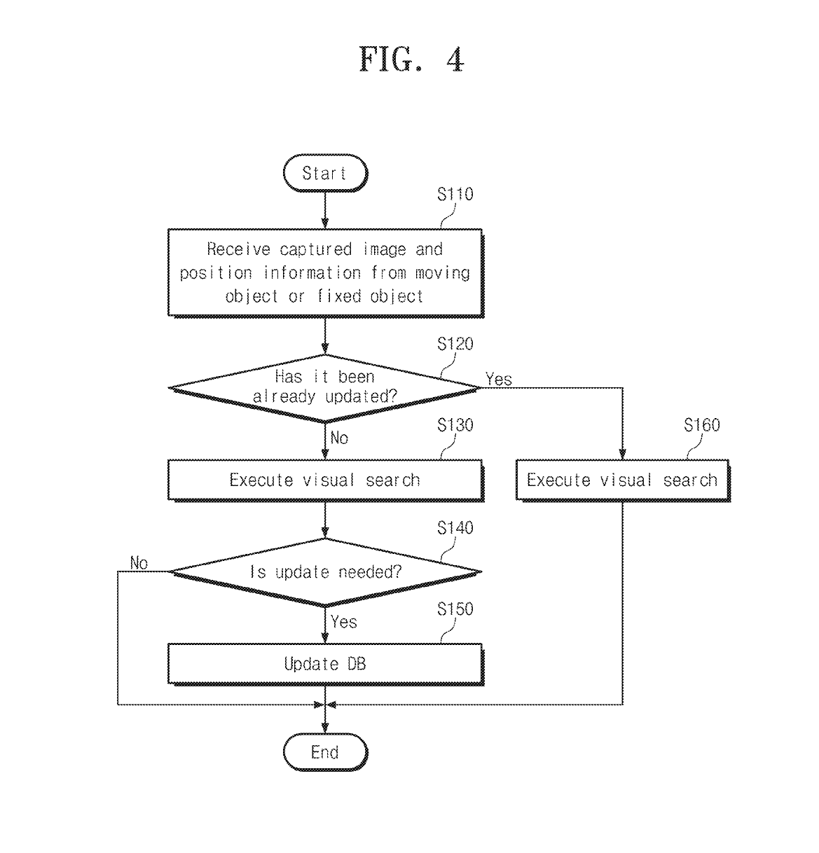

FIG. 4 is a flowchart of the operating method of a visual search system according to an embodiment of the inventive concept.

In step S110, an image of a target and position information thereon may be received from a moving object or a fixed object. For example, the position information on the moving object may be information that is based on a GPS. A visual search update server may identify the position information on the moving object or the fixed object based on position information that is received from the moving object or the fixed object. The identified position information on the moving object or the fixed object may be used for facilitating a visual search or an update to the image of the target. For example, by limiting the range of the visual search (or update) to characteristic information corresponding to a region to which the moving object or the fixed object belongs, it is possible to enhance the speed of the visual search (or update).

In step S120, it is possible to determine whether an update to a corresponding region has been recently executed. Here, the corresponding region may mean a region to which the moving object or the fixed object belongs. According to a determination result, an operation is divided. If it is determined that the update has been recently executed (Yes), the process goes to step S160. If not (No), the process goes to step S130.

In step S130, a visual search operation is executed. According to the visual search operation, it is possible to compare characteristic information on the image of the target received with characteristic information stored in a DB so that information on the target may be searched for. The operation of searching the DB may be first executed at a category corresponding to a region to which the moving object or the fixed object belongs. The reason is that there is a high probability that the moving object or the fixed object and the target belong to the same region. Then, the search may be expanded into a category corresponding to a region adjacent to the region to which the moving object or the fixed object belongs.

In step S140, it is determined whether an update is needed. If it is determined that the update is needed, through a comparison of characteristic information on the captured target with characteristic information stored in the DB, it is possible to structurize only a part needing to renew to execute an update. According to a determination result, an operation is divided. If it is determined that the update is needed (Yes), step S150 is executed. If not (No), the process ends.

In step S150, the DB is updated. The update may be executed on a part needing to renew, among pieces of characteristic information on the target.

In step S160, a visual search operation is executed. The present step is substantially the same as step S130. However, since in step S120, it has been determined that the update has been recently executed, a further update may not be considered.

According to an embodiment of the inventive concept, the DB is updated by using both an image captured by the moving object and an image captured by the fixed object. Since it is possible to use both the advantage of the moving object “cost saving” and the advantage of the fixed object “guarantee of data reliability”, it is possible to efficiently update the DB for a visual search.

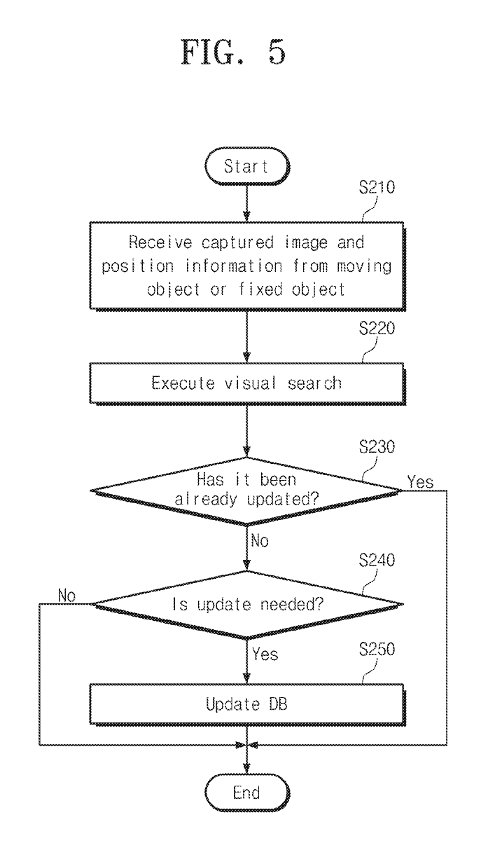

FIG. 5 is a flowchart of the operating method of a visual search system according to another embodiment of the inventive concept.

In step S210, an image of a target and position information thereon may be received from a moving object or a fixed object. Since the present step is substantially the same as step S110 as described in FIG. 4, the redundant description is omitted.

In step S220, a visual search operation is executed. Since the present step is substantially the same as step S130 as described in FIG. 4, the redundant description is omitted. However, unlike the embodiment in FIG. 4, the present step is executed before it is determined whether an update to a corresponding region has been recently executed.

In step S230, it is possible to determine whether the update to the corresponding region has been recently executed. Here, the corresponding region may mean a region to which the moving object or the fixed object belongs. According to a determination result, an operation is divided. If it is determined that the update has been recently executed (Yes), the process ends. If not (No), step S240 is executed.

In step S240, it is determined whether an update is needed. If it is determined that the update is needed, through a comparison of characteristic information on a captured target with characteristic information stored in a DB, it is possible to structurize only a part needing to renew to execute an update. According to a determination result, an operation is divided. If it is determined that the update is needed (Yes), step S250 is executed. If not (No), the process ends.

In step S250, the DB is updated. The update may be executed on a part needing to renew, among pieces of characteristic information on the target.

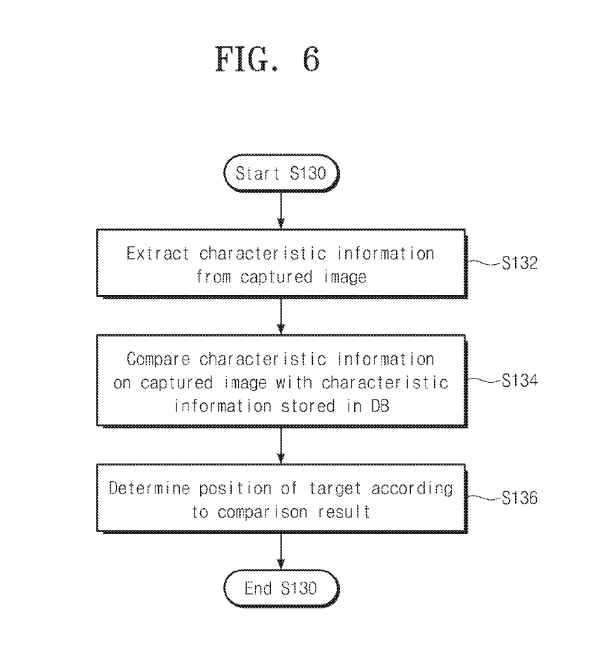

FIG. 6 is a flowchart showing step S130 in FIG. 4 in detail. FIG. 6 may also be equally applied to not only S130 in FIG. 4 but also step S160 in FIG. 130 and step S220 in FIG. 5.

In step S132, characteristic information may be extracted from an image captured by a moving object or a fixed object. The extraction of the characteristic information may be executed by the using of various detectors, such as a Harris detector, a Harris-Laplace detector, an SIFT detector, an MSER detector, and an SURF detector.

In step S134, it is possible to compare the extracted characteristic information with characteristic information stored in a DB. In the present step, if the extracted characteristic information matches the characteristic information stored in the DB, a geometric verification process may also be executed on an image requested from a user.

In step S136, according to a visual search result, information on a target is searched for to be provided to a user.

According to an embodiment of the inventive concept, a DB for a visual search is updated by using images of a target that are received from not only the moving object but also the fixed object. As a result, since it is possible to more efficiently update the DB, there is an advantage in that it is possible to flexibly cope with the frequent change in the exterior of a building that occurs in the complex urban environment.

According to an embodiment of the inventive concept, it is possible to efficiently update a DB for a visual search by using images that are captured by the moving object and the fixed object.

Particular embodiments have been provided in the detailed description of the inventive concept. However, it is possible to implement the inventive concept in different forms without departing from the scope of the inventive concept. Thus, the scope of the inventive concept is not limited to the above-described embodiments and should be defined by not only the following claims but also the equivalents of the claims of the inventive concept.

What is claimed is:

1. A visual search system comprising:
a database configured to store characteristic information on a target, the characteristic information being classified into a plurality of categories according to a region to which a target belongs; and
a visual search update server configured to receive position information on a moving object or a fixed object and an image of the target captured by the moving object or the fixed object, and compare characteristic information extracted from the received image with characteristic information stored in the database to execute a visual search.

2. The visual search system of claim 1, wherein the visual search update server is configured to drive:
a position check unit configured to check a position of the moving object or the fixed object referring to the position information,
an update history check unit configured to determine referring to the position information whether an update to characteristic information corresponding to a region to which the captured target belongs has been executed within a reference period,
a visual search unit configured to extract the characteristic information from the received image, compare the extracted characteristic information with the characteristic information stored in the database to detect a position of the captured target, and determine whether there is a need to renew the characteristic information stored in the DB, and
a characteristic information structurization unit configured to renew characteristic information related to the captured target that is stored in the database, according to a result of the determination.

3. The visual search system of claim 2, wherein the image of the target captured by the fixed object is periodically received by the visual search update server.

4. The visual search system of claim 2, wherein the position information on the moving object is received by the visual search update server according to a request of a user of the moving object, and
the position information on the fixed object is received by the visual search update server or stored in the visual search update server.

5. The visual search system of claim 4, wherein the characteristic information stored in the database is classified into a plurality of groups according to a region to which a target corresponding to the characteristic information belongs.

6. The visual search system of claim 5, wherein the visual search update server detects a position of the captured target with reference to a group corresponding to a region to which the moving object or the fixed object belongs, among the plurality of groups.

7. The visual search system of claim 2, wherein the position information includes information on departure and destination points of the moving object.

8. The visual search system of claim 7, wherein the reference period is determined based on information on the departure and destination points.

9. The visual search system of claim 2, wherein the position information on the moving object is obtained by a global positioning system (GPS).

10. A method of updating a database for a visual search, the method comprising:
receiving an image of a target captured by a moving object or a fixed object and position information on the moving object or the fixed object;
determining whether an update to characteristic information corresponding to a region to which the captured target belongs is executed within a reference period;
according to a result of the determination, executing the visual search by comparing characteristic information on the captured with pieces of characteristic information stored in the database; and
updating characteristic information related to the captured target, from among the pieces of the characteristic information stored in the database.

11. The method of claim 10, wherein the characteristic information on the target is classified into a plurality of categories according to a region to which the target belongs, and stored in the database.

12. The method of claim 11, further comprising, after the receiving of the image, selecting a category for the visual search among the plurality of categories, based on the position information.

13. The method of claim 12, wherein the executing the visual search comprises:
extracting the characteristic information from the image of the target captured;
comparing characteristic information in the selected category with characteristic information on the captured target; and
searching for a position of the target according to a result of the comparison.

14. The method of claim 10, wherein the image of the target captured by the fixed object is periodically received by a visual search update server.

15. The method of claim 10, wherein the receiving the image comprises receiving information on departure and destination points of the moving object.

16. The method of claim 15, wherein the reference period is determined based on information on the departure and destination points.
